(19) United States
(12) Patent Application Publication
(10) Pub. No.: US 2005/0251417 A1
(43) Pub. Date: Nov. 10, 2005

(54) Physicians' remote charge capture system

(76) Inventors: Rakesh Malhotra, Paradise Valley, AZ (US); Zahra Nazneen, Chandler, AZ (US)

Correspondence Address: CAHILL, von HELLENS & GLAZER P.L.C.;Attn: Marvin A. Glazer, 155 Park One, 2141 E. Highland Avenue, Phoenix, AZ, 85016, US

(21) Appl. No.: 10/842,316

(22) Filed: May 10, 2004

(51) Int. Cl. G06F 17/60

(52) U.S. Cl. 705/2

(57) ABSTRACT

A patient management method for hospital-based physicians includes a remote computer server storing certain minimal information regarding patients of one or more physicians. The remote server is linked over a computer network to one or more physician-accessible computers remote from the computer server. Physicians can access such patient information over the network via the physician-accessible computer to view information regarding their patients. Following patient visits, the physician can update patient status information, such as diagnosis, treatment codes, and patient disposition, by entering such information into the server over the network. An administrator in the physician's office can also access the server over a computer network to capture updated patient status information for purposes of workload distribution and/or billing. The interposition of the server between the physician-accessible computer and the physician's office helps ensure compliance with the federal HIPAA Privacy Rule.

### BACKGROUND OF THE INVENTION

1. Field of the Invention

This invention relates to a web based system for physicians, physician extenders and medical practice administrators to facilitate the organization and management of hospital-based services provided by physicians to patients.

2. Description of the Related Art

The practice of medicine in the hospital environment is fast evolving into a specialty of its own. Traditionally, family physicians and physicians practicing general Internal Medicine saw their patients in the hospital. Presently, more and more Internal Medicine and Family Physicians are opting out of this area of their practices. Their patients are now being followed in the hospitals by fellow physicians, called Hospitalists, trained in Internal Medicine and/or Pulmonary Medicine sub-specialty of Internal Medicine. Bringing focused attention to acutely ill and hospitalized patients is being recognized all over the country, and the world, to be infinitely better for patient care, for meeting the unique of needs of this subset of the patient population, and for resource utilization.

Handling and managing a large amount of paperwork is routine and typical for and in physician practices, especially for physician services rendered in a hospital setting. Keeping accurate records for each patient visit and service is vital for carrying out many hospital related tasks including, but not limited to, patient admission, evaluation, treatment, physician assignment, workload distribution, discharges and billing. The labor and time demanded by the large amount of paperwork creates an extremely inefficient environment, and very often vital information has to be recreated for completing various tasks related to the aforementioned services. Additionally, valuable physician time is taken away from direct patient care and is spent on maintaining accurate records and in filling out needed paperwork.

The privacy requirements imposed by HIPAA regulations further complicate the administration of a physician's practice. HIPAA stands for the “Health Insurance Portability and Accountability Act of 1996”, primarily intended to allow easier entry into employee-sponsored group health plans for employees with preexisting conditions. However, HIPAA also includes rules designed to protect an individual's medical privacy. The drafters of HIPAA were concerned that the rapid advancement of technology posed a great risk of global distribution of a patient's private medical information virtually at the click of a button. In 1999, a proposed Medical Records Privacy Act was published, and final rules were published in December of 2000. The Privacy Rule applies to health plans, health care clearinghouses and health care providers who conduct certain financial and administrative functions. President Bush allowed the rules to take effect on Apr. 14, 2001, and physicians were given until Apr. 14, 2003 to comply with the new Privacy Rule. Physicians must now take reasonable efforts to limit the disclosure of patient health information to that which is reasonably necessary to provide proper medical treatment.

Accordingly, one of the objectives of the present invention is to provide a widely available, portable, and accessible on demand, web based system for capturing physician visits and services for hospital based patients.

Another objective of the present invention is to provide a centralized system accessible by hospital based physicians and physician extenders, from anywhere at any time, containing relevant information necessary for running a hospital based physician's practice.

Another objective of the present invention is to provide an online system which allows hospital based physicians and physician extenders, from anywhere at any time, to enter, update, and obtain necessary information for running hospital based physician's practices.

Another objective of the present invention is to significantly reduce the amount of paper and labor required for data entry for billing purposes.

Another objective of the present invention is to provide a system which delivers the aforementioned objectives while remaining compliant with current HIPAA regulations.

Other objectives and advantages of the present invention will be apparent from a review of the following specification and accompanying drawings.

### SUMMARY OF THE INVENTION

Briefly described, and in accordance with a preferred embodiment thereof, the present invention provides an information network system accessible by physicians, physician extenders, and their administrative staff and other personnel, containing patient information. The system allows a physician and/or a physician extender or his/her administrator to enter, update and obtain information regarding hospital based patients, including information related to patient identity, diagnostic condition, treatment and billing. The system greatly facilitates the organization and management of many vitally important tasks, including but not limited to, patient/physician contact, diagnoses, level of services rendered or procedures performed, patient status monitoring, and physician workload management and distribution.

More specifically, the present invention provides a method for managing patient information pertinent to hospital-based physicians' practices wherein a computer server is provided at a site that is located remote from one or more hospitals visited by such physicians, for example, a data center . . . Patient information regarding patients of a physician (or group of physicians) is stored in the memory of the computer server; by way of example only, such patient information might initially be entered by a physician upon, or shortly after, the physician's first encounter with such patient. The patient information stored in the memory of the computer server preferably includes at least the minimum necessary information required by a physician or physicians under the federal HIPAA Privacy Rule to properly treat his/her patients.

The method of the present invention also includes the step of providing one or more physician accessible computers remote from the computer server, for example, within the hospitals visited by such physician. The method of the present invention further includes the step of linking each physician accessible computer to the computer server over a computer network. This computer network could be a public computer network, like the Internet global computer network, or a private Intranet-type computer network. In practicing the method of the present invention, a physician accesses the computer server via a physician accessible computer over the computer network, thereby allowing the physician to view information regarding the physician's patients. Ideally, the present method includes the steps of providing a printer coupled to the physician accessible computer for allowing a physician to print the names, diagnostic information, and hospital room numbers of patients to be visited by the physician. While the information viewed by the physician may be less than the entire amount of information collected about such patient on the computer server, the physician is nonetheless provided with at least the minimal amount of information required by the physician to competently treat such patient. Such information might include, for example, the name of each patient, the hospital name and hospital room number for each hospitalized patient, previously-entered diagnostic information for each patient, previously-entered primary care/referring physician information, and previously-entered treatment information.

The method of the present invention further includes the step of the physician entering additional information into the computer server via the physician accessible computer over the computer network to update the status of a patient following a visit of such patient by the physician. For example, a physician might enter updated medical diagnostic information, updated medical treatment information, and disposition information indicating whether the patient will continue to receive medical treatment in the hospital. Ideally, all data transfers between the computer server and physician accessible computers are performed in a secure manner, as by encrypting data transmitted therebetween.

Preferably, the method of the present invention includes the further steps of providing an office computer in the administrative offices of such physicians, and storing in the memory of such office computer information relating to patients of the physician. In practicing such preferred method, the office computer is linked to the computer server over a computer network, which might be the same computer network used to link the computer server to the physician accessible computers. The present method preferably permits an administrator in the office of the physician to access the computer server via the office computer over the computer network in order to capture updated patient status information entered by the physician following the physician's visit of each patient. In the preferred embodiment of the present invention, this captured updated patient status information may be used by the administrator in the physician's office for purposes of billing the physician's services. The office computer may also be used, if desired, to transfer additional patient information from the office computer to the computer server to supplement patient information already stored in the memory of the computer server. Such supplemental patient information might be helpful, or required, in the event that the computer server is caused to interface directly with a billing clearinghouse to bill health plans for the physician's services. Once again, data transfers between the computer server and such physician's office computers are preferably performed in a secure manner, as by encrypting data transmitted therebetween.

In the preferred form of the present method, access to the computer server by a physician includes the step of first verifying the identity of the physician before permitting such access, as by comparing personal identity information entered by the physician at the start of each access request with personal identity information previously stored in the server computer. Likewise, access to the computer server by an office administrator preferably includes the step of first verifying the identity of the administrator before permitting such access. If desired, the degree of access afforded to a particular physician or administrator can be a function of the identity of such physician or administrator.

Preferably, the present method allows physicians to view historical information regarding patients of such physicians, as by displaying a list of patients visited by such physicians on a specified date. If desired, such listing can be narrowed to patients visited by such physician on the specified date at a particular hospital.

The method of the present invention may also be used to manage and balance patient loads on a group of physicians who share a common practice. For example, the computer server may be used to store patient information for all patients of such practice group. Either the administrator, or senior physicians, can reassign patients among such group of physicians to better distribute patient responsibility among such group of physicians.

In many instances, a patient might not have had any prior contact with a physician, or with the physician's office, until the physician's initial examination of such patient in a hospital, for example, within the emergency room. In such instances, it may be necessary for a physician to initially gather information about such patient(s) which extends beyond the minimal information subsequently needed by the physician to provide subsequent care to the patient. Accordingly, the present method allows for entry, into the computer server, of more detailed information relating to a new patient initially seen by such physician for the first time in a hospital; for example, such additional information might include the date of birth and health plan for such new patient. The physician, or physician extender, may enter this information into the computer server, by way of example, using a physician-accessible computer provided in a hospital, over the Internet or other computer network. This more detailed patient information can later be captured by the administrator in the physician's office, as by downloading such information from the computer server over the computer network onto the physician's office computer. In other instances, more detailed patient information can be entered onto the computer server by an administrator in the physician's office; some or all of such information may then be made available for viewing by a physician via a physician-accessible computer.

The above-described method of the present invention allows administrators and other authorized personnel to access patient information in a manner which complies with current HIPAA regulations. Additionally, the present method can be integrated with billing software to greatly reduce the administrative labor involved in conventional billing methods. While the present invention enhances the overall needs, and meets the ever changing demands, of the specialty of Hospitalist physicians, those skilled in the art will appreciate that it can also be applied to several other specialties of medicine dedicated to providing physician services in the hospital environment.

### BRIEF DESCRIPTION OF THE DRAWINGS

FIG. 1 is a flow chart depicting a general overview of the system of the present invention.

FIG. 2 is a flow chart of a website for use by administrators within a physician's office.

FIG. 3 is a “Report Selection” web page for block 16 within the website of FIG. 2.

FIG. 4 is a “Patient Assignment” web page for block 42 within the website of FIG. 2.

FIG. 5 is a “Census” web page for access by physicians.

FIG. 6 is a “New Patient” web page for use by physicians, and linked to the Census web page of FIG. 5.

### DETAILED DESCRIPTION OF THE PREFERRED EMBODIMENTS

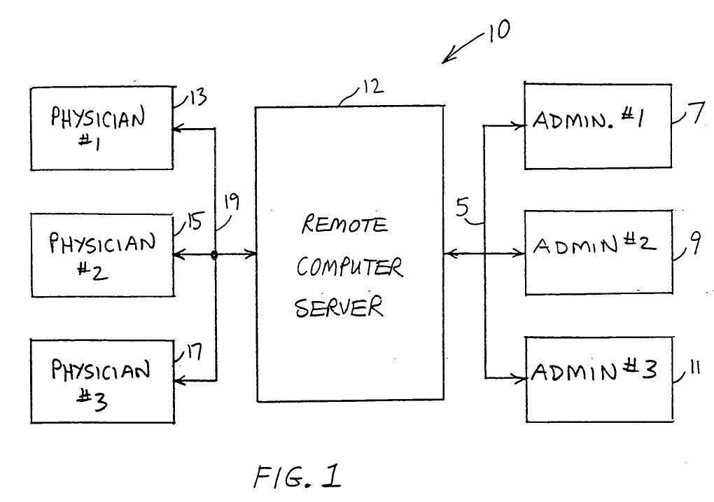

In reference to FIG. 1, a method of using the present invention includes a system 10 including central server 12 containing information related to patients of one or more hospital-based physicians. System 10 can be remotely accessed online, e.g., over the Internet, by hospital based physicians, physician extenders, administrators, and other personnel. The server 12 is capable of receiving, storing, and displaying information related to hospital based patients, and can be set up to serve one or more hospitals, while serving multiple physicians simultaneously. The server 12 can be set up by an independent entity, if desired. Alternatively, server 12 can be established by a group of physicians, or by physician practice groups, all of whom wish to practice the present method.

Computer server 12 is typically located at a site (e.g., a data center) remote from the hospital(s) visited by the physicians who access server 12. Server 12 includes a memory, such as a computer hard drive, for storing patient information regarding patients of those physicians who will be accessing server 12.

As shown in FIG. 1, one or more physician-accessible computers 13, 15, and 17, are provided at sites located remote from computer server 12, and are available for use by physicians. These physician-accessible computers 13, 15, and 17 are linked to computer server 12 over a computer network 19, which, in the preferred embodiment, is the global computer network known as the “Internet” or “World Wide Web”. While not limited thereto, physician-accessible computers 13, 15, and 17 may be located in one or more hospitals that are visited by participating physicians. In this manner, a participating physician can make use of such physician-accessible computers upon first arriving at a hospital, and just before leaving the hospital. While not shown, each such physician-accessible computer may include a printer coupled thereto for allowing a physician to print the names and hospital room numbers of patients to be visited by the physician. Alternatively, one or more of physician accessible computers 13, 15, and 17 might be located in the home of a participating physician. Thus, a physician could access computer server 12 over the Internet from his/her home and print out the list of patients to be visited and corresponding hospital room numbers before leaving for the hospital that morning. Likewise, a physician could use his/her home computer in the evening for linking with computer server 12 to update the status of each patient visited earlier that day.

Likewise, FIG. 1 also shows three office computers 7, 9, and 11 which might represent computers located in the offices of three different medical practices, or alternatively, three different computers located in the offices of a single practice. Each such office computer is controlled by an office administrator, or other personnel, and includes memory for storing detailed information relating to patients serviced by physicians who are members of such medical practice group(s). Each of such office computers 7, 9 and 11 is linked to server 12 over computer network 5. While shown as separate computer networks, computer network 19 and computer network 5 may be the same computer network, if desired. Once again, in the preferred embodiment, office computers 7, 9 and 1 are linked to server 12 by the global computer network known as the “Internet” or “World Wide Web”. Typically, computer server 12 will be located at a site that is remote from office computers 7, 9 and 11. Alternatively, if computer server 12 is hosted, maintained, and operated by one of the participating medical practice groups, rather than by a separate data center business entity, the linkage between computer server 12 and the office computer of the hosting medical practice might be achieved via a local area network, or intranet.

In order to minimize the likelihood that private patient information might be inadvertently disclosed to unauthorized persons, and to better comply with HIPAA privacy regulations, patient information maintained on computer server 12, and made available to physicians, is typically less extensive than the total amount of information maintained for each such patient on computer server 12. Even in those instances wherein a physician initially enters detailed personal information (e.g., date of birth, health plan, etc.) for a new patient, such information need not be displayed to physicians (or to unauthorized third persons attempting to access computer server 12) who subsequently log on to computer server 12 after such new patient information is stored on computer server 12. In some instances, it may be desired to limit patient information maintained on computer server 12 to be less extensive than corresponding patient information maintained on the office computer maintained by the administrator in the physician's office. Thus, the information maintained on computer server 12 may be less comprehensive than patient information maintained in office computers 7, 9, and 11.

At least once each day, and more often if desired, office computer 7 accesses server 12 to capture updated patient information entered by one or more physicians who practice in the physicians' group serviced by office computer 7. Likewise, office computers 9 and 11 would access server 12 at least once each day to capture new information entered by physicians who practice in those respective medical groups. This captured information typically includes the name of the visiting physician, the names of patients visited, updated diagnoses, updated treatment codes, and any updated disposition information. As explained in greater detail below, the captured information may also include more detailed information about a new patient first seen in the hospital that day.

For security reasons, each physician, administrator, or other user of the server 12 has personal identity information (i.e. name and password, biometric data, etc.), which such user must enter to access server 12. Such personal identity information is used by the server to verify the user's identity by matching server-stored identity information with information provided by the user at the start of each access request. In a given log-in session, a user can simply view information, or provide additional information to server 12, then store or save the information on server 12 for later capture. Information is organized on the server based on information fields provided by the server. Information can be further organized or grouped according to a user's specified request. The user's access to information stored on server 12 may be limited, based on the user's status/identity.

According to a preferred embodiment of the invention, a physician accessing server 12 via one of the physician-accessible computers (13, 15, 17) only has access to information necessary for carrying out his/her unique tasks, such as a patient's name, hospital name, date of admission, date of service, medical record number, hospital room number, primary care/referring physician's name, diagnoses and procedures performed. Any more extensive information maintained on computer server 12 related to patient identity (e.g., the patient's address, social security number, health plan, etc.) is not accessible to the physician or physician extenders via the physician-accessible computers, but is only available to office administrators or other personnel located in the physician's office. Thus, the web pages accessible to a physician logging on to server 12 via one of the physician-accessible computers (13, 15, 17) are typically different than the web pages viewable by administrators logging on to server 12 via one of the office computers (7, 9, 11).

Other security safeguards in which the user's identity information (senior physician, associate physician, physician extender, etc.) determines the extent of database access available to that user, may also be employed. For example, a database accessible to a particular physician may be limited to information regarding only the patients being treated by that physician, or to patients seen by a group of physicians based in the same hospital or hospital network in which the particular physician ordinarily works.

Also, the user may indicate parameters for limiting the database which s/he would like to view, such as patient admission date, hospital name, the name of a treating doctor, or any combination of parameters. For example, the user may indicate a date and hospital name to view a list of patients admitted to the named hospital on the date indicated.

Information contained on the database of server 12 can be entered and updated at any time from anywhere by authorized users of the server. This provides physicians and administrators with round-the-clock access to the most recent information available, without having to rely on the presence of personnel staff and/or processing of paperwork. This is especially useful for physicians on call, who may need immediate access to patient information, such as which patients need to be seen; the hospital room number in which the patient can be found; the treatment and diagnoses recorded for a particular patient by another physician; which patients have been discharged; and contact information for the physicians in the group and/or the patient's primary care physician(s).

The system of the present invention is also useful for carrying out administrative tasks such as billing, by making the necessary diagnostic and treatment data readily available to the administrator. The server database may also be integrated with software for performing billing tasks, or may partially function as a billing program, to greatly reduce the amount of labor needed in manually entering data into an independent billing program. In this regard, it is possible to allow computer server 12 to interface directly with a billing clearinghouse on-line to directly bill patient's health plans for services provided by physicians. The server database may also be useful in carrying out statistical analysis, such as reporting relative workloads of various physicians within a medical practice; determining lengths of stay and readmission rates, using industry standards; notifying primary care physicians of their patients' status; and conducting patient and primary care satisfaction surveys.

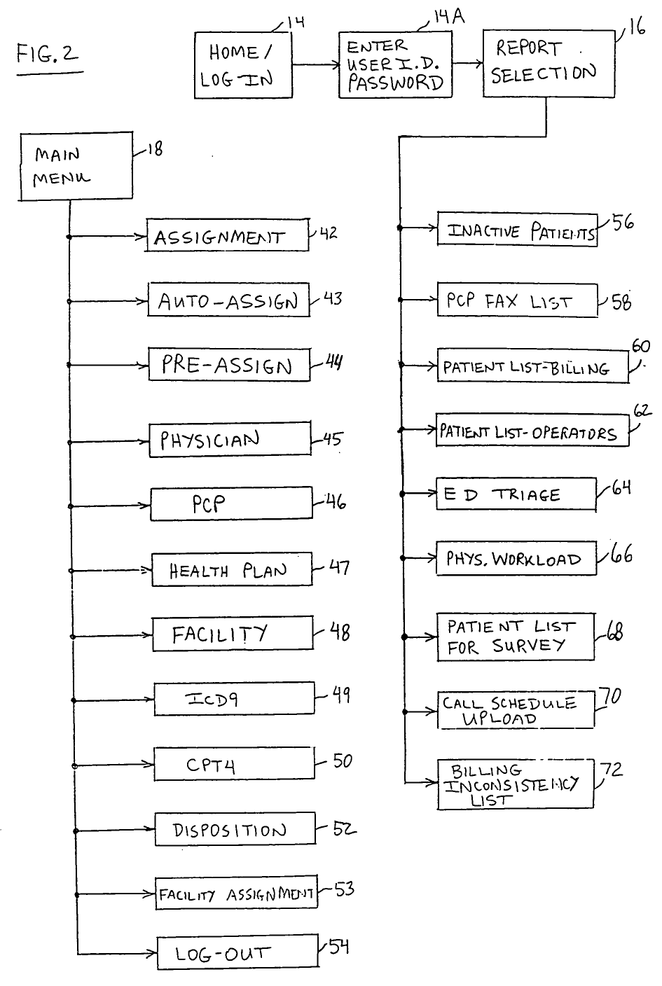

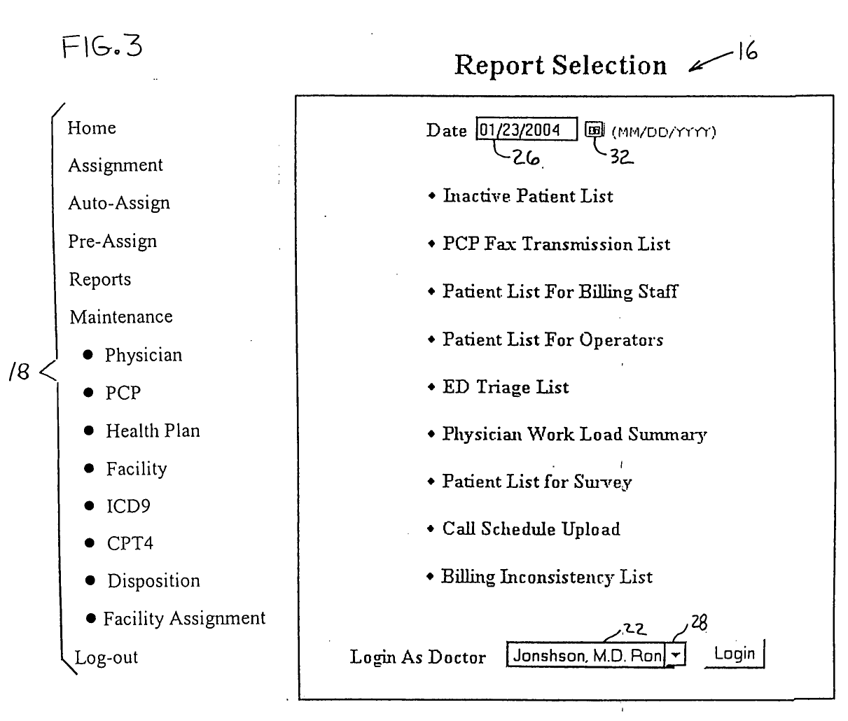

With reference to FIG. 2, a web site for use by physicians' administrators includes “Home” page 14 for logging in, requiring the user to enter a user ID and password, as indicated by box 14A. Once successfully logged into the system, the user/administrator is linked to a “Report Selection” page 16, the appearance of which is shown in FIG. 3. As shown on the left-most side of FIG. 3, menu 18 lists various options for links to other pages on such website. Menu 18 is represented graphically within FIG. 2 by block 18, from which the administrator and/or physicians working in administrative capacity may link to the other boxes 14 and 42-54 shown in FIG. 2.

The options on menu 18 also appear on other linked pages of the website that are viewable by administrators, and include Home 14, Assignment 42, Auto-Assign 43, Pre-Assign 44, Reports 16, Physician 45, PCP 46, Health Plan 47, Facility 48, ICD9 49, CPT4 50, Disposition 52, Facility Assignment 53, and Log-out 54. As shown in FIG. 3, the administrator may also log-in as a physician (as by typing the name of a physician in field 22, or by selecting a physician's name via drop-down arrow button 28) to assist and instruct a physician in better understanding the operation and benefits of the present management system.

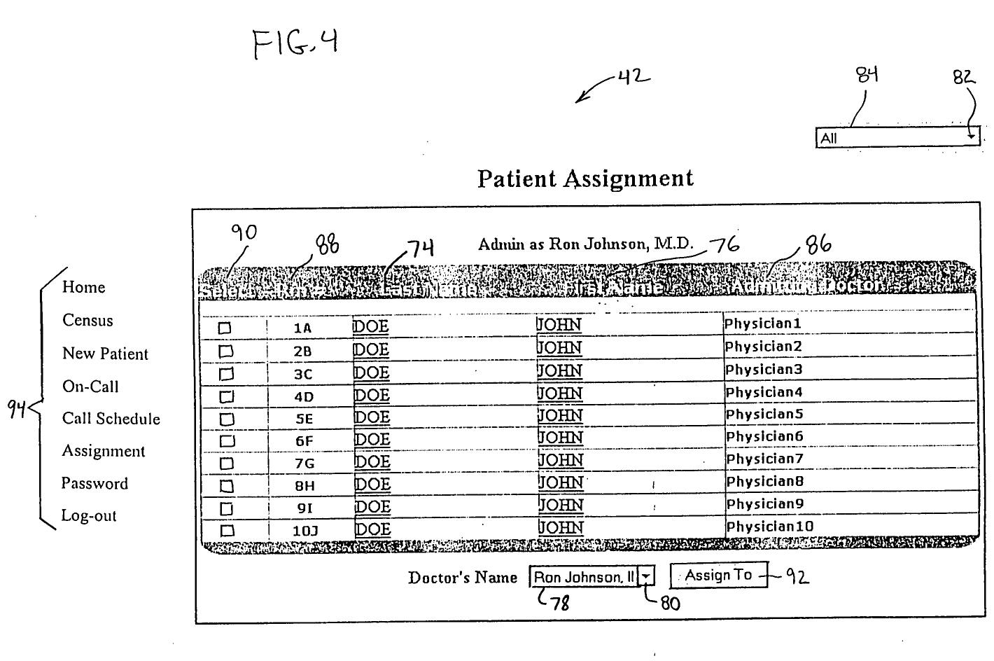

Assignment option 42 is available to both administrators and physicians, and takes the user to a web page having the appearance shown in FIG. 4. Patient Assignment page 42 displays a list of patients assigned to a certain physician; the physician to whom such patients need to be assigned to is displayed in window 78, and the name of such physician may be selected from among a list of the physicians practicing within a group practice by clicking on the down-arrow button 80, which causes a drop-down window of physicians' names to be displayed so that one such name can be selected. Patient names are displayed in two columns corresponding to last name (column 74) and first name (column 76).

Assuming that the selected physician sees patients at more than one hospital, the Patient Assignment page 42 shown in FIG. 4 displays all patients at all hospitals of a particular physician or only those patients admitted to a particular hospital. A specific hospital can be selected by clicking on the drop-down arrow button 82, which causes a drop-down window to appear for allowing the user to select a desired hospital, or “All” hospitals, as illustrated in FIG. 4. The user's hospital selection is displayed within window 84. Patient Assignment page 42 also displays the name of the physician who admitted each patient in column 86, as well as the hospital room number (see column 88) to which such patient has been assigned.

Patient Assignment page 42 of FIG. 4 can be used to change the assigned physician, for one or more displayed patients, by clicking on one or more of the left-hand selection boxes 90 next to the name of each patient for which a new assignment is to be made. The user then specifies a new responsible physician in field 78, and then clicks the “Assign To” button 92 to automatically update the assigned physician for the selected patient(s). This page helps physicians and administrators to distribute the physicians' patient load, and quickly and efficiently re-assign a patient to a different physician, in the event of physicians' absence for any reason at any time during a patient's stay in the hospital. Finally, web page 42 in FIG. 4 also displays menu 94, the menu available to physicians; the various options within menu 94 are explained in greater detail below.

Returning to FIGS. 2 and 3, the Pre-Assign option web page 44 may be used by an office administrator to make a delayed re-assignment of patients to take effect at midnight (or some other desired time) following the use of such web page. For example, suppose that, at midnight every Friday night, a patient's usual hospital-based physician (Physician 1) is off from work until the following Monday morning. Further suppose that a different on-call physician (Physician 2) is responsible for such patient during such 60 hour period. The office administrator may then use the Pre-Assign web page 44, say at 4:00 pm on Friday afternoon, to specify that Physician 2 is to be pre-assigned to the patients of Physician 1 effective at midnight Friday evening (or effective at some other desired time specified by the administrator). Any users who log-in before midnight of Friday evening will see that such patients are still assigned to Physician 1, and any users who log-in after midnight of Friday evening will now see such patients assigned to Physician 2. The office administrator can log-in once more on Sunday afternoon (perhaps from the administrator's home computer), and again using the Pre-Assign web page 44, can specify that all such patients are to be re-assigned back to Physician 1, effective at midnight Sunday evening (or some other desired time specified by the administrator).

Still referring to FIGS. 2 and 3, the Auto-Assign option 43 can be used to simplify the task of the administrator on Sunday afternoons. Using the Auto-Assign web page 43, the administrator can select a former work date (perhaps the previous Friday), have the computer server 12 search its records to determine which patients were assigned to which physicians on the specified prior work date, and then have all patient assignments revert back to the physicians who saw such patients on the last specified work date. Moreover, like the Pre-Assign option 43 mentioned above, the effect of this Auto-Assign option can be deferred until midnight (or some other specified effective time) following the use of such web page by the administrator. This Auto-Assign feature can be used in a “blanket” fashion to include all physicians in the practice group, or it can be exercised physician-by-physician, if desired, specifying the name of a particular physician, and specifying a last work date for each such physician.

Physician option 45 in menu 18 of FIGS. 2 and 3 is a web page that allows the administrator to add or delete physicians from a practice group, and to specify or update contact information for each such physician in the practice group. This web page lists the names of hospital-based physicians grouped in a shared medical practice, along with contact information, such as telephone, telefax numbers, mobile cellular telephone number, pager number, and e-mail address. This list, like all others, is automatically arranged, by default, in an alphabetically ascending order based on the last name of the physician. A search for a particular physician can be conducted using his/her last name.

The “Physicians” page also allows new information to be added and existing information to be updated or deleted, and further lets physicians change their password for logging into the system.

The PCP option 46 in menu 18 of FIGS. 2 and 3 is a web page that allows the administrator to add or delete primary care physicians for patients being serviced by a particular practice group. This web page can be used to list the names of primary care physicians, their group affiliation, and their contact information, including telephone numbers, fax numbers, and e-mail addresses. This page also allows new information to be added and existing information to be updated or deleted. As before, this list is automatically arranged, by default, in an alphabetically ascending order based on the last name of the physician. A search for a particular physician can be conducted using his/her last name.

The Health Plan option 47 in menu 18 of FIGS. 2 and 3 is a web page that lists the names of various health plans which insure patients being serviced by the practice group, along with related information, including contact information. The page can also be used to search for a specific health plan using key words or letters. Other information which may be listed includes fax number, address, and secondary contact information. The page also allows the user to delete and add new health plan companies to the list, and change the information for existing listings. This list is likewise automatically arranged in an alphabetically ascending order based on the name of the Health Plan.

The Facility option 48 in menu 18 of FIGS. 2 and 3 is a web page that lists the names, addresses, telephone numbers, and names of principal contacts, etc. for various hospitals and/or health care facilities which provide services to patients of a hospital-based physician using the present system. This menu selection allows an administrator to add new hospital/facility names and related information to the list, and to update any outdated information regarding such facilities. This list is automatically arranged in an alphabetically ascending order based on the names of the facilities.

The ICD9 option 49 in menu 18 of FIGS. 2 and 3 is a web page that allows an administrator to update and delete or enter new descriptions and corresponding codes in accordance with the International Classification of Diagnosis (numbered 9 in accordance with the current version), and provides a list of existing ICD9 codes and corresponding medical descriptions. This list is automatically arranged in alphabetically ascending order and can be searched using specific ICD9 codes or description.

The CPT4 option 50 in menu 18 of FIGS. 2 and 3 is a web page that allows the user to update and delete or enter new descriptions and corresponding codes in accordance with the current Common Procedural Terminology (numbered 4 in accordance with the current version), and provides a list of existing CPT4 codes and descriptions. This list is automatically arranged in ascending numerical order and can be searched using specific CPT4 codes or description:

The Facility Assignment option 53 is a web page by which the administrator can assign a primary hospital (or “base hospital”) or similar facility to each physician in the practice group. One or more secondary facilities can also be assigned to each such physician.

Finally, Log-out option 54 takes the user to a web page to confirm that the user wishes to log-out of the practice management system. Once logged in either by the physician or the administrator and if there is no activity for 15 minutes, the preferred embodiment will automatically log the user out, if s/he has not done so himself/herself.

Still referring to FIGS. 2 and 3, Report Selection web page 16 also allows an administrator to run several different reports by clicking on one of several links, including Inactive Patient List 56, PCP Fax Transmission list 58, Patient List for Billing Staff 60, Patient List for Operators 62, ED Triage List 64, Physician Workload summary 66, Patient List for Survey 68, Call Schedule upload 70, and Billing Inconsistency List 72. Each of these linked pages is described in more detail below.

The “Inactive Patient List” selection 56 takes an administrator to a web page displaying a listing of inactive patients. Inactive patients are those who have been indicated as having been discharged from the hospital, or who are no longer the responsibility of a particular physician practice group. In the event that a discharged patient did not actually leave the hospital as planned during the previous day, for any reason, s/he can be reactivated by clicking on a reactivate icon (not shown). The patient thus reactivated will automatically be reassigned to the physician who last saw the patient, or such patient can be assigned to another physician. In any event, the responsible physician then needs to update the reactivated patient's CPT4 and Disposition entries for the previous day. This report can be used by the administrator in the physician's office to compare with hospital records to confirm that the listed patients have indeed been discharged from the hospital. If a patient listed as “discharged” is subsequently found to still be in the hospital, the patient's record is automatically reactivated by updating the patient's disposition and CPT4 information, without having to re-enter all of the other information concerning such patient. Once reactivated in this manner, the patient reappears on a physician's list of active patients to be visited in the hospital when making rounds, or can be assigned to another physician.

The “PCP Fax List” selection 58 on Report Selection web page 16 can be used to view all fax transmissions for the previous day to alert primary care physicians (PCPs) of the status of their hospitalized patients. Each such telefaxed report can list all patients of a particular primary care physician, and is transmitted by facsimile to the office of the primary care physician on a daily basis, including the disposition status of each such patient. Thus, the primary care physician can easily be notified, on a daily basis if desired, as to which of his/her patients are active, which have been discharged, and to where they have been discharged. This web page may also serve as a log of fax transmissions to primary care physicians, allowing an administrator to confirm successful transmission of such faxes, including the date and time of each such transmission. For any failed transmissions, the facsimile can be resent by simply clicking on a “Resend” icon (not shown). In addition to notifying the PCP of his/her patient's status, this tool is also utilized for performing PCP satisfaction surveys seeking valuable input to enhance the services to them and their patients.

The “Patient List For Billing” option 60 on Report Selection web page 16 is adapted to list information used by administrators for billing purposes. Such reports can list patients seen by a physician in a particular hospital, along with the service date. Alternately, such reports can list all patients seen by a physician at multiple hospitals visited by such physician, along with the service date. These reports can be further grouped according to health plans in order to generate a separate report for each different health plan, thereby facilitating the billing of each such health plan. Such reports include physician name, hospital name, date of service, patient name, ICD9 Codes without description, CPT4 treatment code(s), Disposition/Status, and any other information required by health plans to authorize payment for the services rendered by the hospital-based physician. Of particular note is that, while the physician sees and selects a descriptive textual diagnosis, the administrative staff receives corresponding ICD9 Codes, since health plans accept only ICD9 Codes on claim submission forms.

The “Patient List For Operators” option 62 on Report Selection web page 16 can be used to pull up on an administrator's computer screen an automatically alphabetized list of patients being serviced by physicians in a group practice, along with the identity of the particular physician currently assigned to each such patient. This web page can be used by telephone receptionists in the physicians' office for more easily identifying which physician should receive each incoming telephone call regarding a particular patient. This list is automatically updated throughout the day and as new patient information is entered by the physician after first seeing the patient.

Still referring to FIGS. 2 and 3, the “E D Triage List” selection 64 on Report Selection web page 16 can be used to view patients seen by a hospital-based physician within the emergency room of a hospital, although such patients were not formally admitted to the hospital. Such a report may also be generated and used for billing, to assure adequate follow up, and for tracking purposes

The “Physicians Workload” summary option 66 on Report Selection web page 16 brings up a web page showing the relative distribution of a practice's active patients among the physicians who share such practice. For example, this page may indicate the number of patients visited on a given day, or during a given week, by each physician within a common medical practice. As mentioned above, patients may be reassigned among the physicians within a common group, if desired, to better balance the workload of such physicians. Such patient re-assignments can be effected via the “Patient Assignment” page 42 described above in conjunction with FIG. 4.

The “Patient List for Survey” option 68 on Report Selection web page 16 is provided to list names and addresses of those patients, who have been recently discharged from the hospital, and to whom a patent satisfaction survey should be sent to provide feedback to the medical practice for maintaining and improving patient satisfaction with the medical services rendered.

The “Call Schedule Upload” option 70 on Report Selection web page 16 is a web page that displays the work schedule for the physicians in a group practice for each hospital serviced by the practice. The administrator can use this web page to upload to computer server 12 physician call schedules, which might take the form of a Microsoft® Excel® spreadsheet, showing each physician's call shift in each given month for a given hospital. In essence, the aforementioned spreadsheet informs the physicians which physician is to be screening new admissions at which hospitals on which dates and during what times of any given day. It indicates the dates on which physicians are on-call, and the dates on which each physician is off.

Finally, the Billing Inconsistency List option 72 on Report Selection web page 16 is a web page used by administrators to detect patients who appear to be “active” (in the sense that such patients' Disposition status does not show the patient being discharged) whereas no updates have been entered on the status of such patient by a physician for more than a specified number of days. In other words, if a physician in the practice has not visited an “active” patient for more than two days, for example, but the patient is not recorded as having been “discharged”, then the administrator is alerted to follow-up on such patient to see if, perhaps, the responsible physician forgot to update the disposition of such patient after discharging such patient.

Each of the aforementioned reports can be displayed on the administrator's computer screen, saved to disk, printed, and/or automatically telefaxed, as desired.

While not illustrated in FIG. 3, various other reports may be generated, if desired. For example, an administrator may wish to print a hospital report summarizing patient activity and/or physician activity for a given hospital on a specified date. If desired, reports can be telefaxed to health plans, clinical case managers and/or disease management teams.

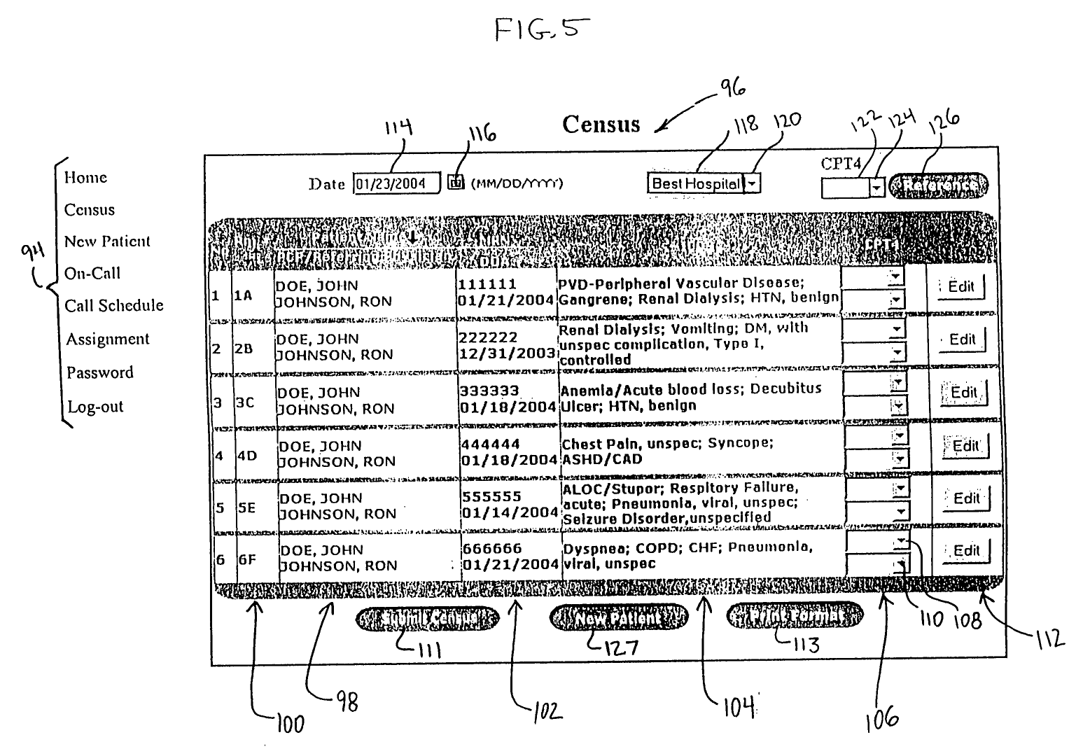

Thus far, the description of the present management system has focused upon access and usage by administrators. The present description now turns to access and usage by physicians. A participating physician logs in to the computer server 12 via one of the physician-accessible computers (13, 15, 17) shown in FIG. 1. After confirming the user identification and password of the physician, the user is directed initially to a Census web page shown in FIG. 5. As shown in FIG. 5, the physician's Census web page 96 again includes menu 94 (also shown in FIG. 4); menu 94 provides a smaller number of link menu options in comparison to the administrator's menu 18 (see FIG. 3). The link options in menu 94 include Home, Census, New Patient, On Call, Call Schedule, Assignment, Password, and Log-out selections. The Home page is the page first encountered by the physician when attempting to access computer server 12; it includes entry fields for the physician to enter his/her name and password for verification.

Still referring to FIG. 5, Census page 96 includes a column 98 list patient names assigned to a particular physician, and the name of such patient's primary care physician, or referring physician, appears below each such patient name. The listing of patient names within Census page 96 may be organized in alphabetical order, based on the patients' last names, in either ascending or descending order; the patient names list may also be sorted by hospital room number, or in any other convenient fashion. Census page 96 also includes a column 100 indicating the hospital room number where such patient can be found. Census page 96 further includes column 102 which specifies, for each listed patient, a medical record number (MRN) and the patient's date of admission to the hospital (DOA). Census page 96 additionally includes a column 104 setting forth the medical diagnoses listed by International Classification of Diagnosis codes (ICD9).

Census page 96 also includes a column 106 for indicating medical procedures performed by the physician on the patient listed by Common Procedural Terminology codes (CPT4); each patient row includes two CPT4 fields with drop down arrow buttons, for example buttons 108 and 110 for patient number 6. By clicking on such drop down arrow buttons, a drop down window appears listing the various CPT4 codes for physician treatment. The physician can scroll through the list of such CPT4 codes to locate the code that best describes the treatment performed; clicking on the selected CPT4 code causes such code to be entered in the corresponding CPT4 window in column 106.

It will be noted that, along the top portion of Census page 96, there is a date field 114, along with a calendar button 116. The physician can pull up a Census page for any specified date, allowing the physician to review historical information (past diagnoses, past treatment codes, etc.) for particular patients, if desired. Also appearing along the top of Census page 96 is a Hospital field 118, along with a drop down selection button 120. A physician who visits more than one hospital can use drop down button 120 to select a specified hospital from a list of the hospitals serviced by the practice group. The selected hospital is then displayed in field 118, and only those patients being cared for in the selected hospital are listed on Census page 96. Also provided along the top of Census page 96 is a CPT4 reference window 122 and drop down arrow button 124. Window 122 and button 124 function in a manner similar to that already described above for buttons 108 and 110, except that window 122 is provided as a reference tool to allow a physician to see an expanded definition of a selected CPT4 code by clicking on the Reference button 126. After selecting the CPT4 code of interest in window 122, clicking on Reference button 126 causes a window to drop down containing a more detailed explanation of the medical treatment, as described in the reference book published annually by the American Medical Association (AMA), corresponding to the selected CPT4 code.

In addition, Census page 96 includes an Edit button column 112 containing an Edit button for each listed patient. Clicking on one of such Edit buttons takes the user to a new web page that permits a physician to 1) alert the administrator for the need to perform certain maintenance tasks; and/or 2) modify the disposition of the selected patient. In some instances, a physician may need to alert the administrator that the current list of a) primary care physicians (PCPs); b) diagnosis codes (ICD9s), and/or c) treatment codes (CPT4s) needs to be supplemented. Accordingly, the physician can use the Edit web page to type in the name of a new PCP; a description of new diagnoses (ICD9); and/or a description of a new treatment (CPT4) to alert the administrator that such maintenance tasks need to be performed by the administrator to update the current list of PCPs, ICD9s, and/or CPT4s.

If there is no change in the patient's hospital room number, diagnoses, or disposition, then the physician need merely enter the appropriate CPT4 code for the current visit on the Census web page. No other information needs to be entered or changed. This saves valuable time on a daily basis, and frees up the physician to devote his/her time to patient care.

As mentioned above, the Edit web page may also be used by the physician to indicate a change in the disposition of the patient following the physician's last visit of such patient. The default disposition code is “None”, indicating that the patient is staying in the hospital for further observation and/or treatment. However, a physician can change such default disposition code when a patient is no longer going to be under the care of such physician. The various disposition codes indicate whether or not the patient is still in the hospital and, if not, it tells the user where the patient went upon leaving the hospital. Typical entries include “None” (indicating that the patient is still in the hospital and considered current or active), “AMA” (indicating that the patient left hospital against medical advice), “Deceased” (indicating that the patient has expired), “Home” (indicating that the patient was discharged to the patient's own home), “Home-HHA” (Home Health Agency, indicating that the patient has been sent home under agency care), “Hospice” (indicating that a terminally ill patient was discharged to a Hospice center for comfort care), “Sign Off” (i.e., the patient is no longer a responsibility of the physician in question), “SNF” (indicating that the patient was transferred/discharged from the hospital to a Skilled Nursing Facility), “Transfer O/F Practice” (indicating that the patient was transferred to another physician in a different medical practice, typically within the same hospital), and “Transfer W/I Practice” (indicating that the patient has been transferred to another hospital or facility, but within the same group/practice). One of such disposition codes is always associated with each patient being tracked by the present method. For obvious reasons, it is important to track which patients are still in the hospital under the care of the practice group, and which patients are not.

Note that when a physician chooses either the “Home” or “Home-HHA” disposition status, two drop down fields appear, namely, a D/C Medications field and a Follow Up field. In the D/C Medications field, the physician types in all relevant information regarding the patient's list of medicines being prescribed at the time of discharge, thus minimizing medication errors. This information can then be telefaxed to the patient's primary care physician (PCP) along with notice of the patient's discharge. In the Follow Up field, PCPs name appears automatically from previously entered information, and the discharging physician has only to enter further specifics, for example, time frame within which the follow up should occur, or which other physician(s) must the patient follow up with and when and what specific test(s) or procedure(s) the patient must have, if any. In addition, these fields provide for printing a typed prescription sheet containing all medicines being prescribed by the physician at the time of discharge. This duly signed prescription sheet, with only quantity and number of refills to be filled in by the physician, can be handed over to the patient at the time of discharge, to be taken to the pharmacy for dispensing the same. This most important information, at the time of discharge can be handed to the patient in a printed and legible format further reducing potential medication errors. Whenever a patient is expected to leave the hospital and an appropriate CPT4 code is used, the invention alerts the physician to dictate a discharge summary and also alerts the physician to follow appropriate coding procedures. This allows for complete physician control for coding of their services and potentially prevents costly audits which may impose significant penalties for errors, inadvertent or otherwise.

When a physician has completed the entry of new CPT4 codes for visited patients, and has completed making any “Edit” entries for such patients, the physician clicks on the “Submit Census” button 111 which appears along the lower portion of Census web page 128. Clicking on Submit Census button 111 saves to the database of computer server 12 all updated information entered by the physician for all such patients in the physician's census. After such submission, the “Submit Census” button disappears, indicating that the Census has been successfully submitted and reappears, for resubmission, if any subsequent changes are made to the Census. This is reflected in the “Patient List For Billing” for the administrative staff to carry on their duties.

Those skilled in the art will appreciate that a physician may print a copy of Census web page 96 for the current date before starting his or her rounds at a hospital, and thereby have a convenient listing, or Rounding Sheet, to guide the physician to the rooms of each patient to be seen by such physician that day at the selected hospital. As shown in FIG. 5, web page 96 includes a “Print Format” button 113, and clicking on such button allows a physician to print out a copy of the Census listing in accordance with any desired format. Such a printed rounding sheet provides hospital room numbers, patient names, prior diagnoses, and PCP/Referring physician's name for each patient. This is useful when a physician does not have continuous access to a laptop or desk top computer with Internet access, or does not want to, or need to, frequently log onto, and out of, the system using a computer. The physician can carry the printed Census page 96, or rounding sheet, listing the patients to be seen for the day, and write down any changes directly on such rounding sheet, including new, diagnoses, new treatment codes, and any changes in patient disposition; the physician can later enter such information into computer server 12 by logging into the system when leaving the hospital, or at the end of the day from the physician's home.

It will be appreciated that information for patients who are active is automatically carried over to the next day's Census listing without having to re-enter the information. Thus, unless a particular patient's disposition has been changed from “None” to something else, a patient seen on one day will automatically appear on a physician's Census page for the next succeeding day. If a given patient on any given day is on the list but had left the hospital the previous day, unbeknownst to the treating physician, such patient's census can be deleted by simply clicking on the delete button that also appears when the “Edit” icon is selected. The physician at the same time updates the disposition for the previous day and resubmits the Census, thus making the patient inactive. Accordingly, a physician need not wait for an update from administrative personnel or the hospital database before making rounds.

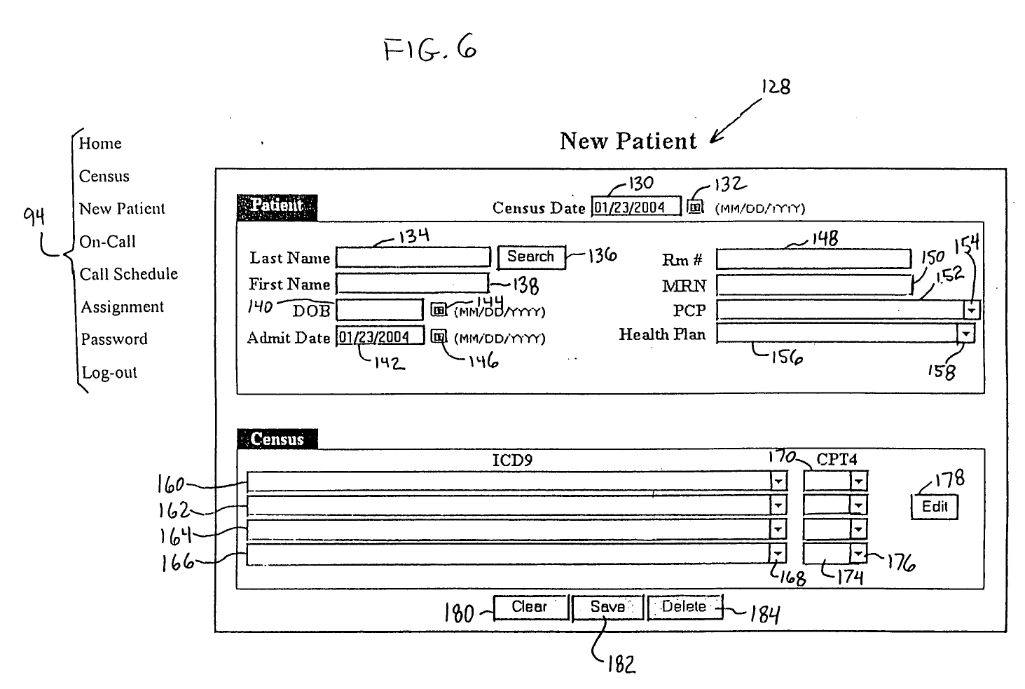

Referring to the Census web page shown in FIG. 5, menu 94 includes a link designated “New Patient”. In addition, a “New Patient” button 127 appears along the bottom portion of web page 96. Clicking on the “New Patient” link directs the physician to a New Patient web page 128 shown in FIG. 6. New Patient web page 128 facilitates the entry of new patient information by a physician or physician extender upon the first encounter with such patient. The New Patient web page 128 includes a Date window 130 and a calendar button 132. Clicking on the calendar button 132 displays a drop down calendar window, and the physician may then click on the desired date (typically, the current date); the selected date is then displayed in Date window 114. A physician need not re-enter the name of the hospital when using New Patient web page 128, having already selected the pertinent hospital back on the Census web page 96 using drop down arrow button 120 (see FIG. 5). A physician then types in the patient's last name into Last Name field 134. The physician then clicks on Search button 136 to display a drop down search window of former patients having such a last name that have already been entered into the database of the physician's practice group. This drop down search window displays the last name, first name, date of birth, and MRN for each such former patient. If the physician sees the new patient already listed among former patients displayed in the drop down search window, then the physician clicks on the corresponding former patient name; this procedure automatically fills in some of the remaining fields in New Patient web page 128 based upon the information already stored for such former patient. The physician then has to fill in the Room Number 148, select PCP 152/154, select patient's Insurance 156/158, ICD9 160-168 and CPT4 170-176.

On the other hand, if the drop down search window fails to display corresponding former patient information for this new patient, then this patient truly is a “new patient”. In that event, the physician completes the process of typing in information for the remaining fields of web page 128. New Patient web page 128 includes field 138 for the patient's first name, date of birth (DOB) field 140, and admission date field 142 (which defaults to the current date). For convenience, calendar buttons 144 and 146 are provided adjacent fields 140 and 142 for allowing a user to use mouse clicks to select dates from a displayed calendar, rather than typing in such dates. The physician also enters the hospital room number in which the patient was seen in field 148. The physician also enters the hospital medical record number (MRN) in field 150. The physician also enters the name of the patient's primary care physician (PCP) either by typing it into field 152, or by clicking on drop down arrow button 154 and scrolling through a list of known PCPs to select the appropriate entry into field 152. The physician also enters the patient's health plan, either by typing the name of the plan into field 156, or by clicking on drop down arrow button 158 and scrolling through a list of known Health Plans to select the appropriate entry into field 156.

Still referring to New Patient Web page 128, the lower portion of web page 128 allows a physician to initially enter up to four different diagnoses codes (ICD9 codes) within fields 160, 162, 164, and 166. A drop down arrow button (e.g., button 168) is provided for each such ICD9 field for allowing a physician to scroll through a drop down window of ICD9 codes to select a desired ICD9 code for entry into the corresponding ICD9 field. Likewise, web page 128 allows a physician to initially enter up to four different treatment codes (CPT4 codes) within corresponding fields, including those designated 170 and 174. Each such CPT4 field has a drop down arrow button (e.g., button 176) associated therewith for allowing a physician to scroll through a drop down window of CPT4 codes to select a desired CPT4 code for entry into the corresponding CPT4 field.

New Patient web page 128 also includes Edit button 178, which functions in the same manner as the Edit buttons in column 112 of Census web page 96 shown in FIG. 5. Clicking on the “Clear” button 180 clears all of the data fields on New Patient web page 128 in preparation for entry of information for a different patient. Clicking on the “Save” button 182 saves the displayed information entered for the new patient to computer server 12 for addition to the database maintained at computer server 12 and all the relevant information is displayed on the Census screen, automatically arranged alphabetically in ascending order. Finally, clicking on the “Delete” button 184 causes all information for the selected patient to be deleted from the Census screen.

Incidentally, while New Patient web page 128 has been described primarily for entering information for new patients for the first time, web page 128 may also be used to edit, update, or delete information for existing patients of a practice. Once again, a user can search for an existing patient by entering a last name (or a last name and a first name) in name fields 134/138, and then clicking on the Search button 136 to search for any matches; assuming that the name(s) entered correspond to one ore more previously-entered patients, the matches are displayed in a tabulated list. The physician may then select the appropriate entry, and some of the remaining fields are automatically filled with corresponding previously-entered information for such patient. Any fields requiring updating or correction can then be changed by typing in the new information; the user then clicks on the Save button 182 to enter the updates/corrections, or the entire patient entry may be deleted by clicking on the Delete button 184. Clicking on the Census link in menu 94 returns the user to the Census web page 96 shown in FIG. 5.

Referring again to menu 94 shown in FIGS. 4, 5 and 6, the On-Call link in menu 94 takes the physician to a web page (not illustrated) that lists all patients currently assigned to the group on a specified date. The On-Call web page format is a view only page, is similar to that of the Census web page shown in FIG. 5, does not have CPT4 or Edit buttons and lists all patients who are currently under the care of all the physicians in the group at a particular hospital/facility.

The Call Schedule link in menu 94 (see FIGS. 4-6) allows a physician to view the call schedule established by the administrator (via the Call Schedule Upload feature described above). Once again, the call schedule might have the form of a Microsoft® Excel® spreadsheet showing each physician's call shift in each given month for a given hospital, and showing the dates on which physicians are on-call, and the dates on which each physician is off.

As mentioned above, billing information captured by the physicians group's back office computer can be interfaced with currently-available medical practice billing software. Examples of such billing software include the “Paradigm” practice management system, and Millbrook Practice Manager System, both offered in the past by Millbrook Corp. of Dallas Tex. The aforementioned Millbrook Practice Manager System is now offered as the Centricity® Physician Office—Practice Management system through GE Medical Systems Information Technologies of Carrollton, Tex. Similar billing systems are offered by MISYS Healthcare Systems of Raleigh, N.C.

The medical software industry has adopted a data communication interface standard known as “Health Level Seven” (abbreviated HL7) to promote a degree of plug and play interoperability between healthcare software products from different vendors. This standard provides specifications for electronic data exchange in healthcare environments, and endeavors to standardize the format and protocol for the exchange of certain key sets of data among healthcare computer application systems. Message formats prescribed in the HL7 encoding rules consist of data fields that are of variable length and separated by a field separator character. Rules describe how the various data types are encoded within a field. The data fields are combined into logical groupings called segments. Segments are separated by segment separator characters. Each segment begins with a three-character literal value that identifies it within a message. Segments may be defined as required or optional and may be permitted to repeat. Individual data fields are found in the message by their position within their associated segments. The information captured by office computers 7, 9 and 11 can easily be formatted to the specifications of the HL7 interface for exchange with billing software programs of the type set forth above.

Those skilled in the art will now appreciate that a new and vastly improved method for managing patient information pertinent to a hospital-based physician's practice has been described, in a fast developing and evolving specialty. The described method, in its preferred form, provides a web-based system for capturing physician visits and services for hospital based patients. The described method removes redundancies and enhances communications between inpatient and outpatient physicians for better continuity of care. The described method is flexible and dynamic, while remaining portable and readily available at any time from any where. Moreover, the described method gives physicians the ultimate responsibility to ensure proper coding of their diagnoses and their services, while significantly reducing the amount of labor required to enter data for billing purposes. The described method provides a centralized system accessible by both hospital-based physicians and by office administrators at virtually any time, containing relevant information necessary for running a hospital based physician's practice. Users can enter, update, and obtain necessary information for running a hospital-based physician's practice, while remaining compliant with current HIPAA regulations.

While the present invention has been described with respect to a preferred embodiment thereof, such description is for illustrative purposes only, and is not to be construed as limiting the scope of the invention. Various modifications and changes may be made to the described embodiment by those skilled in the art without departing from the true spirit and scope of the invention as defined by the appended claims.

1. A method for managing patient information pertinent to a hospital-based physician's practice comprising:
a. providing a computer server having a memory, the computer server being located at a site remote from a hospital;
b. storing in the memory of the computer server patient information regarding patients of a physician;
c. providing a physician accessible computer remote from the computer server;
d. linking the physician accessible computer to the computer server over a computer network;
e. accessing the computer server via the physician accessible computer over the computer network to allow a physician to view information regarding patients of such physician; and
f. entering additional information into the computer server via the physician accessible computer over the computer network to allow a physician to update the status of a patient following a visit of such patient by the physician.

2. The method of claim 1 further including the steps of:
a. providing an office computer in an office of a physician, the office computer having a memory;
b. storing in the memory of the office computer information relating to patients of the physician;
c. linking the office computer to the computer server over a computer network; and
d. permitting an administrator in the office of the physician to access the computer server via the office computer over the computer network in order to capture updated patient status information entered by the physician following the physician's visit of such patient.

3. The method of claim 1 wherein patient information stored in the memory of the computer server includes the minimum necessary information required by a physician under the federal HIPAA Privacy Rule to treat the physician's patients.

4. The method of claim 1 wherein the step of the physician accessing the computer server includes the step of verifying the identity of the physician before permitting such access.

5. The method of claim 4 wherein the verification step includes comparing personal identity information stored on the computer server with personal identity information entered by the physician when attempting to access the computer server.

6. The method of claim 4 wherein the type of information stored on the computer server which may be accessed by a physician is determined by the identity of such physician.

7. The method of claim 2 wherein the step of the administrator accessing the computer server includes the step of verifying the identity of the administrator before permitting such access.

8. The method of claim 7 wherein the verification step includes comparing personal identity information stored on the computer server with personal identity information entered by the administrator when attempting to access the computer server.

9. The method of claim 1 wherein the patient information stored in the memory of the computer server includes the name of each patient.

10. The method of claim 1 wherein the patient information stored in the memory of the computer server includes the hospital name and hospital room number for each hospitalized patient.

11. The method of claim 1 wherein the patient information stored in the memory of the computer server includes diagnostic information for each patient of the physician.

12. The method of claim 1 wherein the additional information entered by the physician into the computer server includes medical diagnostic information.

13. The method of claim 1 wherein the additional information entered by the physician into the computer server includes medical treatment information.

14. The method of claim 1 wherein the additional information entered by the physician into the computer server includes disposition information indicating whether the patient will continue to receive medical treatment in the hospital.

15. The method of claim 1 wherein the step of providing a physician accessible computer includes the step of locating the physician accessible computer in a hospital.

16. The method of claim 15 including the further steps of:
a. providing a printer coupled to the physician accessible computer in the hospital; and
b. printing the names and hospital room numbers of patients to be visited by the physician.

17. The method of claim 1 wherein the step of the physician accessing the computer server via the physician accessible computer for allowing the physician to view information regarding patients of such physician includes the step of displaying to the physician a list of patients visited on at least one specified date.

18. The method of claim 17 wherein the physician visits patients located in more than one hospital, and wherein the step of the physician accessing the computer server via the physician accessible computer for allowing the physician to view information regarding patients of such physician includes the step of displaying to the physician a list of patients visited on a specified date at a particular hospital.

19. The method of claim 2 wherein the computer server stores patient information for patients of a plurality of physicians who share a medical practice, and wherein the administrator can reassign patients among such plurality of physicians to distribute patient responsibility among such plurality of physicians.

20. The method of claim 2 wherein the computer server stores patient information for patients of a plurality of physicians who share a medical practice, and wherein at least one of the plurality of physicians can reassign patients among such plurality of physicians to distribute patient responsibility among such plurality of physicians.

21. The method of claim 2 wherein the administrator uses captured updated patient status information entered by the physician following the physician's visit of such patient for purposes of billing the physician's services.

22. The method of claim 1 including the further step of the physician entering into the computer server, via the physician accessible computer over the computer network, information relating to a new patient initially seen by such physician in a hospital.

23. The method of claim 22 wherein the physician's first contact with such new patient is within the emergency room of such hospital.

24. The method of claim 1 wherein the step of linking the physician accessible computer to the computer server over a computer network includes the step of using a public computer network.

25. The method of claim 24 wherein the step of using a public computer network includes the step of using the Internet global computer network.

26. The method of claim 1 wherein the step of linking the physician accessible computer to the computer server over a computer network includes the step of using a private computer network.

27. The method of claim 26 wherein the step of using a private computer network includes the step of using an Intranet computer network.

28. The method of claim 1 wherein the step of linking the physician accessible computer to the computer server over a computer network includes the step of encrypting data transferred between the physician accessible computer and the computer server to make such data transfers more secure.

29. The method of claim 2 wherein the step of linking the office computer to the computer server over a computer network includes the step of using a public computer network.

30. The method of claim 29 wherein the step of using a public computer network includes the step of using the Internet global computer network.

31. The method of claim 2 wherein the step of linking the office computer to the computer server over a computer network includes the step of using a private computer network.

32. The method of claim 31 wherein the step of using a private computer network includes the step of using an Intranet computer network.

33. The method of claim 2 wherein the step of linking the office computer to the computer server over a computer network includes the step of encrypting data transferred between the office computer and the computer server to make such data transfers more secure.
